(19) United States
(12) Patent Application Publication
(10) Pub. No.: US 2010/0186479 A1
(43) Pub. Date: Jul. 29, 2010

(54) METHOD FOR COUNTING AND CHARACTERIZING AGGRESSIVE DIAMONDS IN CMP DIAMOND CONDITIONER DISCS

(75) Inventors: Leonard Borucki, Mesa, AZ (US); Yun Zhuang, Tucson, AZ (US); Yasa Sampurno, Tucson, AZ (US); Ara Philipossian, Tucson, AZ (US)

Correspondence Address: SUGHRUE MION, PLLC, 2100 PENNSYLVANIA AVENUE, N.W., SUITE 800, WASHINGTON, DC, 20037, US

(73) Assignee: ARACA, INC., Tucson, AZ (US)

(21) Appl. No.: 12/359,772

(22) Filed: Jan. 26, 2009

(51) Int. Cl. G01N 3/56

(52) U.S. Cl. 73/7

(57) ABSTRACT

The present invention is a method for determining the location of and distinguishing aggressive diamonds from active diamonds on a diamond conditioner disc, comprising: (a) contacting a diamond conditioner disc with a hard surface, wherein the diamond-containing side of the diamond conditioning disc is facing the hard surface, (b) pushing the conditioner disc a sufficient distance that all diamonds could possibly be scratching the surface at the same time and at least a distance corresponding to the length of the said diamond conditioner disc (c) observing number and position of the scratches left by diamonds on the hard surface to determine the number and position of active diamonds on the diamond conditioner disc, and (d) selecting the diamonds, the marks for which are the most pronounced and which comprise 50% or more of the total furrow area observed for all of the active diamonds in descending order of furrow are plus any diamonds in excess of the number needed to achieve said 50% or more whose individual furrow area is 2% or more, which diamonds are determined to be aggressive diamonds, or impressing the diamond conditioner disc under a load onto a hard surface and the impression of the most aggressive diamonds in the hard surface being confirmed by microscopic examination to in turn confirm the position and aggressiveness of the aggressive diamonds observed or (e) contacting a diamond conditioner disc with a hard surface, wherein the diamond-containing side of the diamond conditioning disc is facing the hard surface, (f) pushing the conditioner disc a sufficient distance that all diamonds could possibly be scratching the surface at the same time and at least a distance corresponding to the length of the said diamond conditioner disc (g) observing number and position of the scratches left by diamonds on the hard surface to determine the number and position of active diamonds on the diamond conditioner disc, (h) the hard surface further comprises a layer of contrasting material such that when the diamond conditioner disc moves across the hard surface, the said diamond conditioner disc crosses the limits of the layer entirely from one end to the other and scratches the layer of contrasting material on the hard surface thereby leaving a visible mark, (i) the said layer is between 8 and 15 microns thick and (j) selecting the diamonds which cut entirely through the said layer allowing backlighting to be easily viewed.

### BACKGROUND OF THE INVENTION

Diamond conditioner discs have been used in CMP processes to great effect to maintain the roughness of polyurethane polishing pads. These discs have been produced and marketed by several vendors to standards of reliable quality and effectiveness. Generally, diamond conditioner discs are evaluated based on, among other things, the total number of diamonds present on the surface of the disc and the number of diamonds remaining after certain specified periods of use or environmental testing. However, the effectiveness of the diamond conditioner disc actually depends not upon the total number of diamonds present on the surface of the disc but upon the number of active diamonds present.

Active diamonds are the diamonds that actually contact and abrade the surface of the CMP pad during CMP processing. The diamonds on more topographically prominent areas of the surface of the diamond conditioner disc and, where diamonds are collected together on the surface of the disc, diamonds that protrude further from the disc surface than others will, from a simple geometric standpoint, be more available to contact a surface such as that of a CMP pad brought into contact with the diamond conditioner disc.

The number of active diamonds present in any given situation depends upon the total number of diamonds on the diamond conditioner disc, their grouping, the surface characteristics of the diamond conditioner disc including the topography and the load on the diamond conditioner disc. Although simple microscopic examination of diamond conditioner disc sectors and estimation based on the geometric patterns of initial diamond placement and surface area have long provided a method to determine an approximate total number of diamonds on the surface of a diamond conditioner disc, to date there has been no simple, reliable, cost effective method to measure the number of active diamonds.

Among active diamonds are certain diamonds that by size, shape and position are significantly more active than other active diamonds and are referred to as aggressive diamonds. These diamonds are responsible for a significant and disproportionate portion of the cutting of the polyurethane CMP polishing disc and additionally are under the highest degree of stress and suffer the most rapid degradation from use. Their degradation, consequently, far more than is true with other active diamonds, is responsible for the decline in performance of the diamond conditioner disc with use. The process by which these diamonds are either lost or rendered less aggressive or non aggressive by breakage, dislocation or the like is called “pulling”.

The number of aggressive diamonds that are pulled and the conditions causing, surrounding or resulting from their being pulled are of considerable interest not only to diamond conditioner disc manufacturers but users as well. To determine the effects of CMP operations on aggressive diamonds, it is first necessary to identify and verify which diamonds are aggressive as opposed to merely active diamonds, and to determine their location so that after the diamonds cease to be aggressive, the site on the diamond conditioner disc can be observed by optical microscope or other means to determine the causes, conditions and effects of this degradation. If the position of active diamonds on the surface of a diamond conditioner disc could be determined easily, and if a method could be determined at the same time to determine which active diamonds were also aggressive, this would allow manufacturers to understand, control and better maintain the quality of the discs in terms of their actual effectiveness in abrading, cutting and roughening the CMP pad during CMP processing.

To date, no effective method has been disclosed for determining the number and position of aggressive diamonds and manufacturers and users have had to rely on such essentially ineffective methods as estimating the total number of diamonds present on the conditioner disc surface.

Moreover, at the same time it is necessary to develop a method for distinguishing active diamonds from aggressive diamonds not solely in terms of appearance, but primarily in terms of the cutting effect these diamonds exert. To date no such method exists in the art. A method of determining the location of active diamonds generally and in the case of aggressive diamonds combined with a method of distinguishing aggressive diamonds from other diamonds would be of very great use to manufacturers and users of diamond conditioner discs for CMP.

For example, U.S. Pat. No. 7,011,566, incorporated herein by reference, describes a method for determining how effectively conditioning of the CMP pad is being conducted. However the method taught by the '566 patent reveals neither the total number of diamonds nor the number of active diamonds present and certainly does not reveal the number or position of aggressive diamonds on the diamond conditioner substrate. This art also does not teach a method for distinguishing between active and aggressive diamonds.

Similarly, in Bubnick et al., “Effects of Diamond Size and Shape on Polyurethane Pad Conditioning,” Abrasive Technologies, 2004, available at http://www.abrasive-tech.com/pdf/effectsdiamond.pdf, incorporated herein by reference, the size and shape of diamonds are taught to be important for the effective life of the diamond conditioner but none of the total number of diamonds, active diamonds, nor aggressive diamonds are either determined or considered nor is a particular shape or size shown to be aggressive or even active in all or even in a significant number of cases. This art also does not teach a method for distinguishing between active and aggressive diamonds.

Also in Bubnick et al., “Optimizing Diamond Conditioning Discs for the Tungsten CMP Process,” Abrasive Technologies, 2002, available at http://www.abrasive-tech.com/pdf/tcmptungsten.pdf, incorporated herein by reference, the authors teach that manipulation of “diamond concentration” together with other diamond characteristics can be instrumental in lengthening diamond life on diamond conditioners but fail to teach how to determine diamond concentration generally, or active or aggressive diamond concentration or position in particular. Again, this art does not teach a method for distinguishing between active and aggressive diamonds.

Additionally, in Goers et al., “Measurement and Analysis of Diamond Retention in CMP Diamond Pad Conditioners,” 2000, incorporated herein by reference, the authors refer to specific alignment and placement of diamonds at the microscopic level on diamond conditioners which would enable one to generally determine the total number of diamonds on the surface of the diamond conditioner disc; however, the number of active or aggressive diamonds cannot be calculated or estimated from the total number of diamonds alone. Although the positions of diamonds can generally be calculated, there is no way to know which among these will be active or aggressive in actual use. The difference in the number of active diamonds to total surface diamonds is at least two to three orders of magnitude and the difference between active diamonds and aggressive diamonds is another order of magnitude yet.

Goers et al. does not provide either a description of active diamonds or aggressive diamonds, a discussion of their importance or a means of determining how many active or aggressive diamonds are present or where they are particularly located. This art although it does attempt to characterize diamonds more likely to have an effect on conditioning from the standpoint of diamond size and structure, does not, in fact, teach a method for distinguishing active from aggressive diamonds in terms of their functional effect. In other words, aggressive diamonds are aggressive not because they look like they might more aggressive be but because they cut more than other diamonds and this is due to a combination of factors making prediction based on any single factor or small group of factors exceedingly difficult or impossible.

In Dyer & Schlueter, “Characterizing CMP pad conditioning using diamond abrasives”, incorporated herein by reference, the authors refer to determining “diamond loss” by microscopic examination of diamonds on the surface of the diamond conditioner disc. In addition to diamonds placed individually on a predetermined grid on the diamond conditioner surface, diamonds arranged in clusters of 1-9 from which an estimate of total diamond number could be made are given but, again, no reference is made to the existence or determination of the position of active diamonds or aggressive diamonds and no method is taught to distinguish between them.

In Zimmer & Stubbmann, “Key factors influencing performance consistency of CMP pad conditioners,” available at http://www.diamonex.com/diabond key factors.htm, incorporated herein by reference, the authors discuss the concept of “working grit density”, which is defined as “the total amount of grit in contact with the pad divided by the total area of the conditioner.” The authors teach that working grit density can be measured “by inspecting the conditioner after usage and counting the number of grit particles which show physical wear compared to the total number of grit particles within a given area. The ratio of the two densities can then be used as a figure of merit for the quality of the conditioner.”

Similarly in Thear & Kimock, “Improving productivity through optimization of the CMP conditioning process,” available at http://www.morganadvancedceramics.com/articles/cmp_optimization.htm, incorporated herein by reference, the authors define “working grit density” as “the number of grit particles that show physical wear compared to the total number of grit particles within a given area. This calculation is made by inspecting the conditioner after use and is used to indicate the quality of the conditioner.” However, the post-usage visual inspection procedures taught by these references can only be used effectively on a worn disc and provide no direct information on the active or aggressive diamond count or position at various stages of life. In addition, it is difficult to distinguish between diamonds that wear because they are cutting the pad and those that wear because they make contact but do not cut.

Finally in Borucki U.S. Pat. No. 7,410,411 (2008), incorporated herein by reference, a method is disclosed for counting active diamonds on a diamond conditioner dish by moving the said disc under a load over a polycarbonate sheet and counting the number of marks in the said polycarbonate sheet. Additionally, by making the movement of the said disc very short, it is reported that the positions of active diamonds can be determined. However, this method provides no explanation of how to distinguish from the much larger number of regular active diamonds, the more important aggressive diamonds, which though relatively few in number are responsible for most of the abrasive and cutting effect attributed to active diamonds generally.

Users of diamond conditioner discs need to know that they are receiving the same quality of product from diamond conditioner disc manufacturers from the standpoint of process effectiveness on a consistent basis and such a test would allow users to better determine specifications for what they require. Users may also want to know how well their discs are faring under certain operating conditions and an accurate method of determining the number and position of aggressive diamonds on the diamond conditioner disc will provide them with useful information in that regard. Finally, from a research and development standpoint, the results of such a test would provide makers of diamond conditioner discs with more useful information about how to improve existing manufacturing processes for diamond conditioner discs or in the development of new CMP and related processes.

The present invention seeks to provide an accurate and consistent method for determining the position of aggressive diamonds on a diamond conditioner disc and additionally to provide a reliable method for distinguishing between active and aggressive diamonds. These and other advantages of the invention will be apparent from the description of the invention provided herein.

### BRIEF SUMMARY OF THE INVENTION

The present invention is a method for determining the location of and distinguishing aggressive diamonds from active diamonds on a diamond conditioner disc, comprising: (a) contacting a diamond conditioner disc with a hard surface, wherein the diamond-containing side of the diamond conditioning disc is facing the hard surface, (b) pushing the conditioner disc a sufficient distance that all diamonds could possibly be scratching the surface at the same time and at least a distance corresponding to the length of the said diamond conditioner disc (c) observing number and position of the scratches left by diamonds on the hard surface to determine the number and position of active diamonds on the diamond conditioner disc, and (d) selecting the diamonds, the marks for are the most pronounced and which comprise 50% or more of the total furrow area observed for all of the active diamonds in descending order of furrow are plus any diamonds in excess of the number needed to achieve said 50% or more whose individual furrow area is 2% or more which diamonds are determined to be aggressive diamonds. The invention also provides for methods of measuring furrow area by profilometry and integration and confirming the determination of the position and aggressiveness of the diamonds by subsequent scratch runs at different disc angular orientations with respect to the direction of motion of the disc during the scratch run. Additionally or alternatively, microscopic examination of the surface of the diamond conditioner disc or a hard material sheet surface to which the diamond conditioner disc has been impressed can be used to confirm the aggressiveness of aggressive diamonds once their position and aggressiveness have been ascertained by the methods of the present invention. Moreover, additionally or alternatively, the present invention teaches the determination of aggressive diamonds by means of observation of scratches through a contrasting layer of 8 to 10 microns on the hard surface when the load on the disc during the scratch test is between 1 and 10 lbs.

### BRIEF DESCRIPTION OF THE DRAWINGS

FIG. 1 shows a graph of the profilometric data taken from the scratch test of the hard surface in Example 1.

FIG. 2 sows a graph of the profilometric data taken from the scratch test of the hard surface in Example 1 together with an integration of the furrow area of the furrows in the hard surface showing the relative furrow area of each scratch.

FIG. 3 is 3 photographs showing from left to right the surface of a diamond conditioner disc, the surface impressed against a hard transparent surface and the impression left in the hard surface by an aggressive diamond.

### DETAILED DESCRIPTION OF THE INVENTION

Applicants have developed a method for accurately and consistently determining the number and position of aggressive diamonds on the surface of a diamond conditioner disc. They discovered that by determining the number and position on a diamond conditioning disc of active diamonds using an adaptation of the method in U.S. Pat. No. 7,410,411 and then comparing the relative furrow area of the marks of the active diamonds to choose from among them those diamonds whose marks account for 50% or more of the total furrow area observed plus those diamonds in excess of that amount individually having 2% or more of total furrow area as aggressive diamonds they were able to describe consistently a class of diamonds responsible for a far greater amount of the cutting and abrading activity of the diamond conditioner disc than simple number would indicate. This is the furrow area profilometry embodiment.

These aggressive diamonds, whose positions on the diamond conditioner disc are thus clearly determined, may then be observed again using the methods of U.S. Pat. No. 7,410,411 but in more than one procedure or “scratch diamond count test”, at different angular orientations of the conditioner. If the “intensity” of the marks are comparable in all orientations, and are adequate to meet the standard accounting for, with the other aggressive diamonds, more than half of the total furrow area observed, then the diamond is further confirmed to be an aggressive diamond. Additional or alternative confirmation may be achieved by visual examination using an optical microscope of the surface of the diamond conditioner disc or of a plastic or other impressible hard material sheet in an impression test once the essential location and aggressiveness of the aggressive diamonds have been determined. This is the hard surface impression embodiment. Further additional or alternative confirmation of or determination of aggressive diamonds may be made by means of observation of scratches through a contrasting layer of 8 to 10 microns on the hard surface when the load on the disc during the scratch test is between 1 and 10 lbs. This is the contrasting layer scratch embodiment. Of the three embodiments of the present invention described herein, the furrow area profilometry embodiment is preferred because of the three the result for number and identity of aggressive diamonds is least affected by the degree of load. In the case of the hard surface impression embodiment or the contrasting layer scratch embodiment the number of aggressive diamonds will change dramatically with the change in load. However, with the furrow area profilometry embodiment, though some of the weakest aggressive diamonds may fail to appear entirely at lighter loads, aggressive diamond status is determined by relative furrow area as a part of the total furrow area observed and since the most aggressive diamonds will cur a furrow at even light loads and since whether the load is light or heavy this furrow will comprise a significant portion of the total, the results of this embodiment will be less susceptible to change with load which should consistently yield a more reliable result.

There will naturally be some variation in the number of aggressive diamonds recognized even on the same disc since there are variations depending upon the alignment of the diamond conditioner disc during the test and the implications for which side of the diamond is more suited for cutting, what other diamond or feature of the disc may be enhancing its performance at a particular angle and so on. Such variation is understandable given the nature of the factors determining whether a diamond is active or aggressive. However, the difference between the maximum and minimum count for aggressive diamonds is orders of magnitude smaller than the total number of diamonds on the conditioner discs, which can number in the hundreds of thousands, and even much smaller than the total for active diamonds, which can number in the hundreds. It is likely that the number of diamonds that change from active to aggressive depending on the orientation test will be negligible and in any case it is unlikely that any of the most aggressive diamonds would not be aggressive in all circumstances. Even with some variation depending upon angular orientation of the diamond conditioner disc, it is possible to characterize a conditioner disc by a reasonably precise count of aggressive diamonds obtainable using the methods of the present invention now in addition to its active diamond count and total diamond estimated count.

The results of the method of the present invention are easily reproducible and reliable. Moreover, the cost of implementing the method of the present invention is nominal, particularly where the final observation is by optical microscope and the material used to observe the diamond markings is a polycarbonate sheet. Furthermore, the method of the invention can easily be carried out with minimal equipment or preparation though there is nothing to suggest that specific equipment, existing or developed for this purpose, could not be applied to carry out this process in a reliable, trouble free and more reproducible manner, particularly in an industrial context.

In the present invention, the hard surface is not particularly limited, but may consist of any hard smooth material, such as plastic, metal, glass or the like. Materials having a yield strength of between about 65 and about 75 MPa are preferred, and materials having a yield strength of at or near about 70 MPa are more preferred. Preferably the hard material is plastic and as the plastic referred to any hard plastic having a suitable yield strength may be used. Polycarbonate, acrylic, cellulose and the like are preferred plastics, with polycarbonate being more preferred. Preferred acrylic acid polymers include polymethacrylate and polymethyl-methacrylate.

The color, transparency or appearance of the material used in the determination of aggressive diamonds in the contrasting layer scratch embodiment is not particularly limited. Transparent or translucent materials or materials having any degree of color or transparency or any appearance may be used, and are preferred. Where optical methods are used to count the scratches, materials that are to a reasonable degree transparent or translucent and sufficiently visually distinguishable from the thin contrasting attachment or layer across which the scratches are made are preferred.

The color, transparency or appearance of the material is not particularly limited. Any contrastive color may be used for the layer of contrasting material, with black and dark blue being preferred. Transparent or translucent materials or materials having any degree of color or transparency or any appearance may be used, provided however that where optical methods are used to count the scratches, materials that are to a reasonable degree transparent or translucent and sufficiently visually distinguishable from the thin contrasting attachment or layer across which the scratches are made are preferred. Additionally, the solid polyurethane material used in the CMP pads is very suitable as the hard surface of the present invention, provided however that when such non-transparent materials are used, though optical methods of counting the scratches are not ruled out, profilometry is preferred as the counting and position determining method.

As to the form of the hard material, it may be in any suitable form, particularly as the flat surface of a table or flat workspace or a sheet laid upon or clamped to the same, but sheets are preferred, particularly since sheets are inexpensive and easily replaceable between tests, and a permanent surface would require some form of treatment to remove the scratches. The dimensions of the hard surface are not particularly limited but should be sufficient to allow the disc to be moved entirely across the measurement zone, and preferably in the range of about 9 inches in length and about 5 inches in width. It is also desirable that the sheet of the present invention not be so large as to prevent or make difficult observation of the scratches by whatever means are chosen but typically by optical microscope. Dimensions of between about 5 inches and about 8 inches by between about 9 inches and about 12 inches are more preferred, and dimensions of about 8 inches by about 10 inches are even more preferred.

The thickness of the sheet is not particularly limited; however, the sheet should be stiff but still slightly flexible. If the sheet is too thin, the diamond conditioner disc may drag, deform or distort the sheet, thus rendering the number of scratches inaccurate. If the sheet is too thick it may be unwieldy and in cases, particularly where optical transparency or translucency is important for optical measurement or where profilometry is used, may make measurement less accurate. Also, if the sheet is too thick to bend slightly under load, thereby conforming to the flat work surface on which it has been placed, deviations in planarity inherent in the manufacturing process of the sheet may significantly affect the accuracy of the results.

The foregoing dimensions are based upon the present size of the diamond conditioner disc at 4 inches diameter. The dimensions may be adjusted appropriately to adjust for changes in the size of diamond conditioner discs.

The form and material of the layer of contrasting material are not particularly limited, and the layer typically only need be used when optical methods are used to count the number and measure the furrow area of scratches. A thin layer of contrasting material can be applied at any time but preferably is applied at the time of manufacture. For example, a tinted, dyed or pigmented layer can be prepared, painted or applied to the surface of the hard material at any time and either allowed to dry or hardened in some other way indicated by the nature of the material. When dried, hardened or fast, the material should not be so hard as to offer substantial resistance to the diamonds as they scratch the hard material.

On the other hand, the layer should not be so soft that a clear pattern of scratches cannot be reasonably obtained or maintained by the methods of this invention. The materials that can be used for the layer of contrasting material are not particularly limited. In some embodiments, indelible marker ink in a dark color is preferred particularly when the underlying hard material is transparent or white. In other embodiments, dyed or pigmented plastic materials similar to those preferred for use in the hard surface are preferred. The layer of contrasting material may be laminated by any manufacturing technique whereby a strip of material can be permanently incorporated onto another and techniques of lamination of two plastic layers by heat, pressure or, curing or adhesives may be used.

Furthermore, the layer of contrasting material may be laminated or fused into a depression in the hard surface corresponding to the dimensions of the contrasting layer so that the resulting surface is smooth, particularly if this is desirable for purposes of standardization or application with a mechanical device for convenience, precision and reliability. In any case, there should not, as a result of attaching the layer, be such a significant topographic variation in the hard surface as would interfere with the smooth motion of the diamond conditioner disc over the hard surface. Additionally the contrasting layer may consist of infusion or impregnation of pigment, dye or otherwise optically contrasting material at a shallow depth into that region of the hard surface that would correspond to the layer by any suitable means or of similar alteration of the hard surface to render it optically contrasting to such depth.

Where the thin layer of contrasting material is thus added to the hard surface material, the hardness of the layer is not particularly limited. Generally, a hardness similar to or less than that of the underlying hard material is preferred. However a layer of contrasting material that is softer than the underlying hard material should not be so soft or easily smeared or removed that it is difficult as a practical matter to retain the contrasting appearance of the scratches for later measurement. A thin layer of contrasting material of between 8 and 15 microns is preferred, between 9 and 11 microns is more preferred and 10 microns is most preferred. A hard material with such a contrasting layer can be used in the contrasting layer scratch embodiment, independent of other methods of the present invention to determine the position and identity of aggressive diamonds that will render a rough number of aggressive diamonds, or that embodiment may be used as a confirmatory method for other embodiments of the method of the present invention.

The method of application of the layer of contrasting material is not particularly limited and the layer may be applied by coating, casting, curing, painting, spraying, wiping, marking, tinting, pigmenting, or dyeing the hard surface. In some embodiments, the layer of contrasting material is produced by attaching a separate layer to the hard surface, for example, by coating, casting, painting, etc. In other embodiments, the layer of contrasting material is produced by incorporating a material into the hard surface, for example, by dyeing, tinting, or pigmenting the hard surface. Those materials used in the preparation of the layer requiring time to dry or solidify should be given sufficient time to dry before making the scratches.

The dimensions of the layer of contrasting material are not particularly limited. Generally, the length should equal or exceed the diameter of the diamond conditioner disc being tested. In the case of the aggressive diamond determination, the width of the band should be 4 inches or more, preferably 4 and ¼ inches or more and more preferable 4 and ½ inches or more. In the case of confirmation of aggressive diamond determination by additional runs at different angular orientations, the same width may be used but smaller widths as low as ½ inch or less may also be used. Where in conjunction with other embodiments of the present invention, a short scratch test is used to locate undifferentiated active and aggressive diamond positions using the method of U.S. Pat. No. 7,410,411, the conditions taught there should be applied for that purpose.

The position or orientation of the layer of contrasting material with respect to the surface of the hard material is not particularly limited. Any position or orientation that will allow the conditioner disc to be drawn sufficiently across the contrasting layer in a linear fashion can be used. However, it is preferred that the contrasting layer be placed midway down the length of the hard surface and that the longer axis of the contrasting layer be perpendicular to the direction in which the diamond conditioner disc is moved.

The detection of aggressive diamonds is, as stated before, in part, and depending on the embodiment of the present invention used, a function of the load placed on the diamond conditioner disc and the load applied to the diamond conditioner disc is not otherwise limited. The load used in the present invention is selected to reflect actual use conditions of the disc. For either the active diamond determination or the aggressive diamond determination, loads that cause the total weight of the disc and load to be between about 2 pounds and about 25 pounds are preferred (e.g., between about 3 pounds and about 15 pounds, or between about 4 pounds and about 10 pounds).

The means of moving the diamond conditioner disc are not particularly limited, and the conditioner disc may be moved either manually or by a mechanical device prepared for that purpose. For example, the conditioner disc may be pushed, pulled, rotated or swung across the hard surface. Suitable mechanical devices include, for example, machines that are driven electromotively, magnetically, mechanically (for example by pistons, chains, screws, gears or levers), hydraulically, by gas pressure, by hanging the disc on the end of a pendulum and swinging it, though a pendulum may be less effective or at least less manageable for the active diamond determination phase, or by tipping the polycarbonate sheet surface until the conditioner disc slides down the sheet at a reasonable rate. There is no limitation upon the type of drive that may be used at each stage of the process, provided, however, that the same drive and velocity should be used throughout for the scratch diamond count test for the aggressive diamonds and it is preferred to use the same drive and velocity throughout.

Though movement of the conditioner disc is preferred, the hard surface may likewise be moved across the surface of the conditioner disc. The movement of the conditioner disc is preferably linear, though a curved course if carefully controlled may be considered for specific purposes, for example verification of faint scratches. Acceleration or deceleration may be used though a constant velocity is preferred. The velocity of the diamond conditioner disc across the surface of the hard material and the layer of contrasting material, if present, or other equivalent material is not limited but is preferably between about 0.25 inches per second and about 4 inches per second (e.g., between about 0.5 inches per second and about 3 inches per second). The velocity is more preferably between about 1 and about 2 inches per second. Depending upon the material, if the velocity is too small, scratching may be not be accomplished effectively but if the velocity is too great, the underlying material may be distorted in the direction of the movement, substantially decreasing accuracy and precision in the count.

The length of the scratches of the present invention is determined by the distance traveled by the diamond conditioner disc and preferably is long enough to entirely cross the layer of contrasting material. However, the scratches may be any length suitable for optical or, more particularly simultaneous profilometric observation, or any other form of observation used with the present invention. For the aggressive diamond determination of the present invention, a distance of over 4 inches is preferred.

With the determination of aggressive diamonds, in any embodiment or combination of embodiments where optical contrast has been provided by the layer of contrasting material, and the aggressive diamonds have scratched through that contrasting layer, as with the contrasting layer scratch embodiment, observation by optical microscope is preferred.

The means of determining the furrow area of the scratches of the present invention is are not particularly limited and any means that may easily be applied may be used. Optical microscopy and visual determination of the furrow area of individual scratches and profilometry are preferred methods of measuring scratch furrow area and profilometry is more preferred.

To determine the amount of furrow area of each scratch as a percentage of total furrow area, any particular method including measurement by microscopic examination may be used but a software integration program with data from profilometry or optical intensity where a contrast layer is applied are preferred and a software integration program used with data from a profilometer is more preferred.

The standard for aggressiveness of diamonds of the present invention as determined under the furrow area profilometry embodiment, is set at just the number of aggressive diamonds in decreasing order of furrow area necessary to comprise 50% of the total observed furrow area of the scratches of the present invention. The inventors of the present invention found that this 50% figure almost always encompassed all of the diamonds from among the active diamonds on contemporary diamond conditioner discs that exhibited extraordinary cutting or abrading capability. Typically, this 50% consisted of a small minority of the total number of active diamonds and the remaining 50% consisted of the vast majority of active diamonds with marginal or limited cutting or abrading effectiveness. In most cases by the time this 50% furrow area figure has been achieved the last aggressive diamond included within this 50% is a diamond accounting for two percent or less of the total furrow area of all active diamonds of the diamond conditioner disc in question of which past research has indicated number in the hundreds.

There are conceivably occasional cases in which diamonds beyond the 50 plus percent cutoff is still 2 percent of the total furrow area or larger, and for purposes of the present invention, in such cases, any diamond whose furrow area added to the total furrow area of all diamonds with larger furrow areas is in excess of the present invention's fifty percent total furrow area cutoff limit in terms of size ranking but whose individual furrow area is also two percent of the total furrow area or larger is regarded as an aggressive diamond according to the method of the present invention. This could account for the anomalous but mathematically possible case where the first diamond had a furrow area of 30 percent, the second 21 percent and the third 10 percent. The third diamond is above the cutoff limit of the present invention but is clearly still aggressive. This two percent secondary cutoff limit makes it possible to account for such anomalous configurations of diamonds in a way that will meaningfully reflect upon their cutting effectiveness.

As the methods for confirming the aggressiveness of the aggressive diamonds any particular method may be used however, additional runs at alternate angular orientations to verify position, aggressiveness and impression upon a sheet of hard material followed by microscopic examination to verify position and aggressiveness, and scratching across a differently colored layer of 8 to 15 microns thickness to see which diamonds cut all the way through to determine aggressiveness are preferred. The order in which the operations of the method of the present invention may be carried out, is not particularly limited, and a short pull scratch test as described below to locate aggressive diamonds followed by a long pull scratch test with profilometry to confirm the aggressiveness of the diamonds whose position has been determined may be used. An initial long pull scratch test with profilometry followed by alteration in angular orientation, a hard surface impression test according to the hard surface impression embodiment, a contrast layer scratch test according to the contrast layer scratch embodiment any combination of these confirmatory methods may be used. Additionally, Either the impression method followed by the other confirmatory methods of the present invention or the scratch test with 8 to 15 micron differently colored layer may be performed followed either in isolation or followed by the long pull scratch test with profilometry and any or any combination of the other confirmatory methods. It should be noted that the number and ins some marginal cases the identity of the aggressive diamonds will not match for all methods but the most aggressive diamonds will register by any of the embodiments either independently or as confirmatory steps of the present invention.

The number of alternative variations in angular orientation that may be tested by additional scratch runs is not particularly limited but between 2 and 4 is preferred. The variation in the angular orientation of the diamond conditioner disc is not particularly limited but specific easily calculable angles at intervals of 30 degrees, 45 degrees and 90 degrees are preferred. By observing the scratch patterns at different angles the position of particular aggressive diamonds can be verified geometrically and then confirmed by microscopic examination of the diamond conditioner disc surface. TO determine diamonds geometrically, the angular position of the disc during the scratch test is recorded, that is to say the most anterior point on the external circumference or the most posterior point are marked and scratches are then lined up with the disc. It is generally possible in the case of the most significant diamonds to observe microscopically which diamonds are in a line projected from the position of the scratch on to the diamond conditioner disc surface placed in the same orientation as during the scratch test. This initial consideration will take into account all diamonds along the line of the scratch and there is some possibility of more than one diamond possibly accounting for a significant scratch. However, by changing the angular orientation of the disc by a set angle in this step and running the subsequent scratch test, it should be possible to resolve which diamond is creating the scratch. In addition, the short scratch test of U.S. Pat. No. 7,410,411 and microscopic examination can further be used to resolve any remaining ambiguity as to aggressive diamond location. There is the additional benefit in using this angular orientation variation step that if the aggressive diamonds are consistently aggressive regardless of orientation, the confirmation of their aggressiveness is more certain. Geometric confirmation of the location of the aggressive diamond could be obtained by observing the line created by the scratch and how it would cross the disc at a given orientation and then observing the line created by the diamond of the same intensity in a different orientation and the point of intersection of the lines on the disc should be approximately the location of the aggressive diamond. Additionally a positioning of the aggressive diamond could be determined by the method of positioning active diamonds described in U.S. Pat. No. 7,410,411 where a short scratch run of 1/16 to about 3/18 inch is carried out and the starting point of each scratch is observed to correspond to the relative position on the diamond conditioner disc at that orientation where the diamond creating the scratch was observed. The most aggressive diamonds are identifiable visually but whereas this method identifies the position of the most aggressive diamonds a follow up of other runs with measurement of furrow area is necessary to identify all or substantially all of the aggressive diamonds.

The method of impressing the diamond conditioner disc on a hard sheet likewise confirms the position and aggressiveness of the most aggressive diamonds. This method is followed my microscopic examination of the sheet to observe marks made by the aggressive diamonds. This method may be used independently as a quick way of identifying the most aggressive diamonds, as a confirmation for the primary method of the present invention or it may be used in conjunction with multiple scratch runs at different angular orientations.

The hard surface used in the impression test of the present invention consists of any hard smooth material, such as plastic, metal, glass or the like. Materials having a yield strength of between about 65 and about 75 MPa are preferred, and materials having a yield strength of at or near about 70 MPa are more preferred. Preferably the hard material is plastic and as the plastic referred to any hard plastic having a suitable yield strength may be used. Polycarbonate, acrylic, cellulose and the like are preferred plastics, with polycarbonate being more preferred. Preferred acrylic acid polymers include polymethacrylate and polymethyl-methacrylate.

The means of pressing the diamond conditioner disc onto the hard surface of the present invention for the impression test are not limited but methods that permit the amount of pressure or load applied are preferred including application of hydraulic or mechanical pressure on the diamond conditioner disc so that its diamond containing face is forced onto the hard surface with load cells to measure the amount of pressure applied or placing the diamond conditioner disc with its diamond containing face on the hard surface and loading it with weights of known mass may be used and the use of weights is preferred. The length of time the diamond conditioner disc is left in contact with the hard surface under load is not particularly limited but generally any time period from an instantaneous impression to 2 minutes is sufficient and between 0 and 10 seconds is preferred. The amount of load applied to the diamond conditioner disc is not particularly limited but if the load is too large too many active diamonds may leave impressions and if the load is too light too few aggressive diamonds may leave impressions. A load of between 1 lb and 10 lbs is preferred and between 1 lb and 5 lbs is more preferred. The temperature at which the impression may be made is not particularly limited and room temperature is preferred.

### EXAMPLES

The following examples further illustrate the invention but, of course, should not be construed as in any way limiting its scope.

Example 1. A polycarbonate sheet (GE Plastics XL10 Lexan™) having dimensions of 8×10″ by 3/32″ thick was placed on a ⅜″ thick glass plate with a flat, clean surface and onto which constraints had been attached to prevent the horizontal and vertical motion of the sheet. The constraining devices consisted of strips of polycarbonate with at least one straight edge, rectangular aluminum blocks, and metal rulers, all of which were attached to the glass plate with double sided tape.

A used 4.25″ diameter Mitsubishi Materials Corporation Triple Ring Dot (MMC TRD) diamond conditioner disc with a total of approximately 202,000 visible 200 grit diamonds on the working surface was placed diamond face down with its leading edge just touching the closer side of the indelible felt tip maker band and with one edge just touching the left-hand constraint of the sheet. Metal weights, which together with the diamond conditioning disc totalled 7.37 pounds, were placed on the top of the disc. The conditioner disc and metal weights were moved by pushing them from the back using a rectangular Melamine block across the indelible felt tip marker band at right angles to the longest dimension of the band at a rate of about 1 inch per second for 4 inches. The disc and weight were removed, the sheet was removed and the number of scratches was observed using an optical microscope (Nikon SMA-10, 10× magnification). The sheet was viewed with lighting from above.

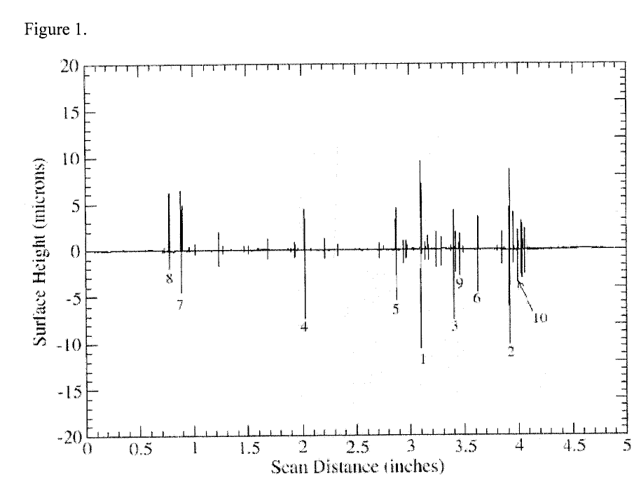

A scanning stylus profilometer (Dektak V200 SI, Veeco Corp.) with a three micron radius probe tip, a horizontal step of 2.778 microns, and a vertical resolution of 0.26 microns was used to scan the surface of the polycarbonate sheet. The scan line was 100 mm long and located just halfway between the beginning and end of the first and last scratches. After data acquisition, variations in surface height due to tilt and non-planarity of the polycarbonate sheet were mathematically removed by constructing a 1000 point running average and subtracting it from the raw height data. The resulting scanning profilometry plot is shown in FIG. 1: FIG. 1. Profilometric Observation of Scratched Hard Surface

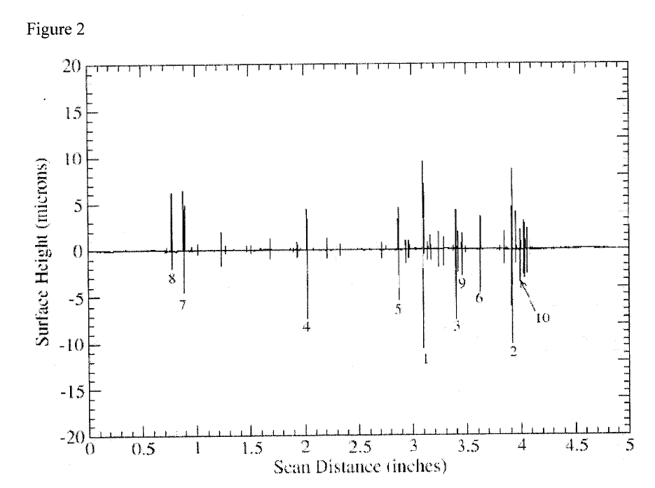

Scratches were then counted automatically using custom software constructed to identify scratches that produce surface variations above the noise level of an unmarked polycarbonate sheet surface. An integration scan was carried out using additional custom software constructed for that purpose. The data was recorded in FIG. 2: Integration Analysis of Profilometric Data and the Furrow Area of the Scratches. Based on this integration scan the total furrow area of all of the scratches and the area of the larger individual scratches were calculated and the area of the larger scratches were added in order of the largest furrow area through progressively smaller furrow areas until the addition of the last area resulted in the total furrow area of the larger scratches added becoming more than fifty percent of the total scratch furrow area observed. The results are shown in Table 1.

TABLE 1
Furrow Area of Aggressive
Diamonds

| | | Cumulative Furrow |
|---|---|---|
| No. | Percent Total Furrow Area | Area |
| 1 | 13.3% | 13.3% |
| 2 | 9.5% | 22.8% |
| 3 | 3.8% | 26.6% |
| 4 | 4.9% | 31.5% |
| 5 | 3.2% | 34.7% |
| 6 | 2.7% | 37.4% |
| 7 | 10.6% | 48.0% |
| 8 | 1.1%* | 49.1% |
| 9 | 1.8% | 50.9% |
| 10 | 1.8% | 52.7% |

*Diamond 8 from Table 1 is the first “non-aggressive” diamond according to the method of the present invention.
The smallest of the furrow areas was less than two percent of the total so there was no need to determine and evaluate which additional furrow areas exceeded 2% of the total area. By this method 10 aggressive diamonds were identified.

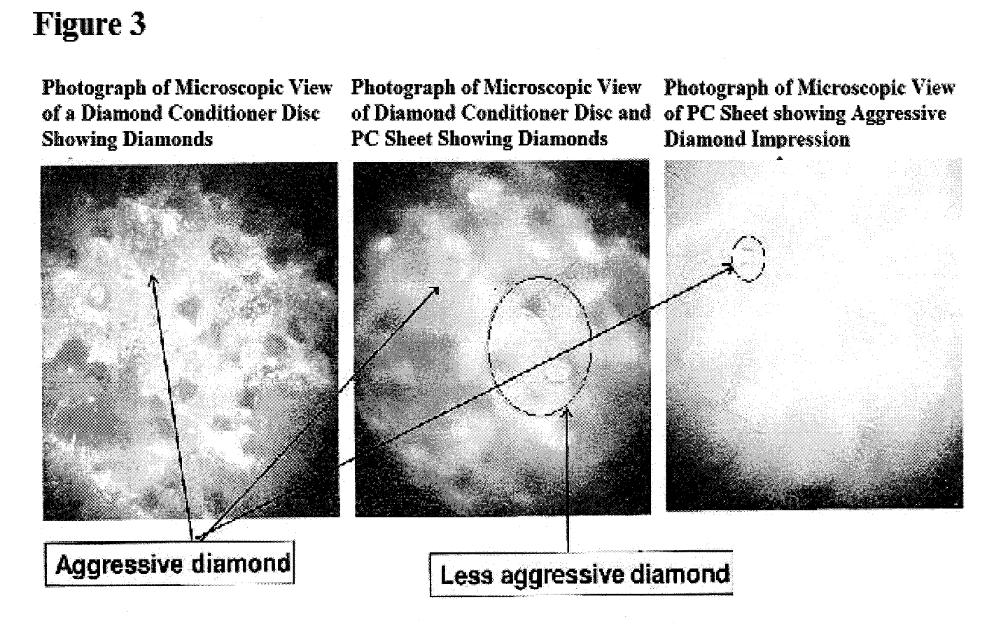

To confirm the aggressiveness of the most aggressive diamonds the conditioner disc used in this example was pressed using a 5 pound weight to the surface of a polycarbonate sheet (GE Plastics XL 10 Lexan™) cut into a circle having the lateral dimensions of the disc and a thickness by 3/32″ thick for one second at a room temperature of about 26 degrees Celsius. The position of the outside of the disc was marked so as to confirm the positions of the diamonds and microscopic observation was conducted using an optical microscope (Nikon SMA-10, 10× magnification) and the aggressive diamonds were observed FIG. 3: Photograph of an Impression on a PC Sheet of Aggressive Diamonds on a Diamond Conditioner Disc Taken by the Impression Method. It is notable how there are many diamonds observed by microscopic examination of the surface which are clearly distinguished by this method as not being aggressive. Even a large or prominent looking diamond may in the final analysis not be aggressive if its contact with the surface is not such that it can cut effectively and at a significantly greater rate and to a significantly greater extent than other diamonds.

Effects of the invention. The invention has the beneficial and heretofore unknown advantage of not only distinguishing those diamonds that cut any of the surface during CMP from those that do not but those few diamonds that do a vast majority of the work in cutting the polishing pad in CMP. The method of the present invention and its confirmatory methods provide a flexible, reliable and relatively reproducible way of determining how many aggressive diamonds are on the cutting surface of a diamond conditioner disc and relatively how aggressive they are. The method is capable of using the apparatus of the prior art in some of its methods and other steps can be accomplished with little or no new special apparatus and relatively little difficulty. The present invention provides a powerful and extremely inexpensive diagnostic tool for use in determining characteristics of different lines and kinds of diamond conditioner discs as well as determining the original and continuing characteristics and effectiveness of individual diamond conditioner discs.

The invention claimed is:

1. A method for determining the location of and distinguishing aggressive diamonds from active diamonds on a diamond conditioner disc, comprising: (a) contacting a diamond conditioner disc with a hard surface, wherein the diamond-containing side of the diamond conditioning disc is facing the hard surface, (b) pushing the conditioner disc a sufficient distance that all diamonds could possibly be scratching the surface at the same time and at least a distance corresponding to the length of the said diamond conditioner disc (c) observing number and position of the scratches left by diamonds on the hard surface to determine the number and position of active diamonds on the diamond conditioner disc, and (d) selecting the diamonds, the marks for which are the most pronounced and which comprise 50% or more of the total furrow area observed for all of the active diamonds in descending order of furrow are plus any diamonds in excess of the number needed to achieve said 50% or more whose individual furrow area is 2%, which diamonds are determined to be aggressive diamonds, or more or impressing the diamond conditioner disc under a load onto a hard surface and the impression of the most aggressive diamonds in the hard surface being confirmed by microscopic examination to in turn confirm the position and aggressiveness of the aggressive diamonds observed or (e) contacting a diamond conditioner disc with a hard surface, wherein the diamond-containing side of the diamond conditioning disc is facing the hard surface, (f) pushing the conditioner disc a sufficient distance that all diamonds could possibly be scratching the surface at the same time and at least a distance corresponding to the length of the said diamond conditioner disc (g) observing number and position of the scratches left by diamonds on the hard surface to determine the number and position of active diamonds on the diamond conditioner disc, (h) the hard surface further comprises a layer of contrasting material such that when the diamond conditioner disc moves across the hard surface, the said diamond conditioner disc crosses the limits of the layer entirely from one end to the other and scratches the layer of contrasting material on the hard surface thereby leaving a visible mark, (i) the said layer is between 8 and 15 microns thick and (j) selecting the diamonds which cut entirely through the said layer allowing backlighting to be easily viewed.

2. A method for determining the location of and distinguishing aggressive diamonds from active diamonds on a diamond conditioner disc, comprising: (a) contacting a diamond conditioner disc with a hard surface, wherein the diamond-containing side of the diamond conditioning disc is facing the hard surface, (b) pushing the conditioner disc a sufficient distance that all diamonds could possibly be scratching the surface at the same time and at least a distance corresponding to the length of the said diamond conditioner disc (c) observing number and position of the scratches left by diamonds on the hard surface to determine the number and position of active diamonds on the diamond conditioner disc, and (d) selecting the diamonds, the marks for which are the most pronounced and which comprise 50% or more of the total furrow area observed for all of the active diamonds in descending order of furrow are plus any diamonds in excess of the number needed to achieve said 50% or more whose individual furrow area is 2% or more which diamonds are determined to be aggressive diamonds.

3. The method of claim 2, wherein the hard surface has a yield strength of about 65 MPa to about 75 MPa.

4. The method of claim 2, wherein the hard surface comprises a plastic.

5. The method of claim 2, wherein the hard surface is in the form of a sheet.

6. The method of claim 2, wherein the hard surface is a plastic sheet.

7. The method of claim 6, wherein the plastic sheet is transparent or translucent.

8. The method of claim 7 wherein scratches are counted visually or microscopically by backlighting the transparent or translucent sheet and viewing it against a dark background.

9. The method of claim 7, wherein the transparent or translucent plastic sheet comprises a hard polymer plastic material selected from the group consisting of polycarbonate, polymethacrylate, and polymethyl-methacrylate.

10. The method of claim 2, wherein the load is between about 2 and about 25 pounds.

11. The method of claim 2, wherein the resulting scratches, the starting points of which correspond to the position of each active diamond, are scratches in the said hard surface.

12. The method of claim 2 wherein the hard surface further comprises a layer of contrasting material such that when the diamond conditioner disc moves across the hard surface, the said diamond conditioner disc crosses the limits of the layer entirely from one end to the other and scratches the layer of contrasting material on the hard surface thereby leaving a visible mark.

13. The method of claim 12, wherein the layer of contrasting material is applied to the hard surface by coating, casting, curing, painting, spraying, wiping, marking, tinting, or dyeing.

14. The method of claim 12, wherein the layer of contrasting material has a contrasting color.

15. The method of claim 14, wherein the layer is a tinted, dyed, or pigmented layer.

16. The method of claim 14, wherein the layer of contrasting material has a contrasting hardness.

17. The method of claim 12, wherein the layer of contrasting material comprises the pigmented material left by an indelible felt marker or similar marking or coloring device.

18. The method of claim 12, wherein the hard surface is a transparent or translucent plastic sheet.

19. The method of claim 18, wherein the transparent or translucent plastic sheet comprises a hard polymer plastic material selected from the group consisting of polycarbonate, polymethacrylate, and polymethyl-methacrylate.

20. The method of claim 19, wherein the layer of contrasting material consists of a plastic sheet having a thickness of between about 0.001 inches and about 0.1 inches and a dark translucent color that is laminated or sealed to the hard surface.

21. The method of claim 2, wherein the means for measuring the furrow area of each individual scratch is a profilometer.

22. The method of claim 21, wherein the means for determining the furrow area of each scratch as a fraction of the total furrow area is an integration program used to analyze the profilometry data obtained.

23. The method of claim 12 wherein aggressive diamonds are confirmed by observing which diamonds cut entirely through the layer allowing backlighting to be easily viewed.

24. The method of claim 2, wherein the hard surface is a rectangular polycarbonate sheet that is clamped to a flat work surface, the hard surface further comprising a layer of contrasting material consisting of a band of constant width greater than the diameter of the diamond conditioning disc applied by marking the hard surface with an indelible felt tipped marker across the upper surface of the polycarbonate sheet perpendicular to the longer axis of the polycarbonate sheet, and wherein the diamond conditioner disc contacts the hard surface such that the lead and trailing edges of the disc are within the band, and wherein the diamond conditioner disc is moved between 4 and 8 inches at a constant velocity parallel to the longer axis of the polycarbonate sheet so that the diamond-containing surface of the disc crosses felt marker band and from the position of the scratch a determination of the position of the diamonds on the conditioner disc is made, following which a profilometer is used to measure the furrow area of the scratches at a point between the start of the most anterior scratch and the end of the most posterior scratch and integrator software is used to calculate the furrow area of each scratch based on said profilometry.

25. The method of claim 2 wherein two or more scratch runs are made with the same disc and the said disc is rotated a known angle from one orientation to the next and the disc is marked to confirm the position of a determinable point for each orientation to determine both the precise position of the aggressive diamonds and consistency of the aggressiveness of the diamonds at different angles.

26. The method of claim 2 where the diamond conditioner disc is subsequently impressed under a load onto a hard surface and the impression of the most aggressive diamonds in the hard surface is confirmed by microscopic examination to confirm the position and aggressiveness of the aggressive diamonds observed.

27. The method of claim 2 wherein confirmation of aggressiveness and position of aggressive diamonds is obtained by two or more scratch runs being made with the same disc and the said disc being rotated a known angle from one orientation to the next and the disc being marked to confirm the position of a determinable point for each orientation to determine both the precise position of the aggressive diamonds and consistency of the aggressiveness of the diamonds at different angles and additionally by impressing the diamond conditioner disc under a load onto a hard surface and the impression of the most aggressive diamonds in the hard surface being confirmed by microscopic examination to in turn confirm the position and aggressiveness of the aggressive diamonds observed.

28. The method of claim 2, wherein the diamond conditioner disc is moved mechanically at a constant velocity parallel to the longer axis.

29. The method of claim 2 wherein the area of the diamond conditioner disc surface in which aggressive diamonds have been identified is examined and photographed by optical microscope to confirm the position and existence of the said aggressive diamonds.

30. A method for determining the location of and distinguishing aggressive diamonds from active diamonds on a diamond conditioner disc, comprising impressing the diamond conditioner disc under a load onto a hard surface and the impression of the most aggressive diamonds in the hard surface being confirmed by microscopic examination to in turn confirm the position and aggressiveness of the aggressive diamonds observed.

31. A method for determining the location of and distinguishing aggressive diamonds from active diamonds on a diamond conditioner disc, comprising: (a) contacting a diamond conditioner disc with a hard surface, wherein the diamond-containing side of the diamond conditioning disc is facing the hard surface, (b) pushing the conditioner disc a sufficient distance that all diamonds could possibly be scratching the surface at the same time and at least a distance corresponding to the length of the said diamond conditioner disc (c) observing number and position of the scratches left by diamonds on the hard surface to determine the number and position of active diamonds on the diamond conditioner disc, (d) the hard surface further comprises a layer of contrasting material such that when the diamond conditioner disc moves across the hard surface, the said diamond conditioner disc crosses the limits of the layer entirely from one end to the other and scratches the layer of contrasting material on the hard surface thereby leaving a visible mark, (e) the said layer is between 8 and 15 microns thick and (f) selecting the diamonds which cut entirely through the said layer allowing backlighting to be easily viewed.

32. The method according to claim 31 wherein the load on the diamond conditioner disc is between 1 lb. and 10 lbs.
